(19) United States
(12) Patent Application Publication
(10) Pub. No.: US 2014/0074524 A1
(43) Pub. Date: Mar. 13, 2014

(54) Method and System for Business Outcome-Based Personalized Ranking of Information Objects

(71) Applicants: Jeffrey S. Boston, Wappingers Falls, NY (US); Tina Groves, Ottawa (CA); Jennifer Lai, Garrison, NY (US); Jie Lu, Hawthorne, NY (US); Shimei Pan, Elmsford, NY (US); Mercan Topkara, Scarsdale, NY (US); Zhen Wen, Chappaqua, NY (US); Stephen P. Wood, Thornwood, NY (US)

(72) Inventors: Jeffrey S. Boston, Wappingers Falls, NY (US); Tina Groves, Ottawa (CA); Jennifer Lai, Garrison, NY (US); Jie Lu, Hawthorne, NY (US); Shimei Pan, Elmsford, NY (US); Mercan Topkara, Scarsdale, NY (US); Zhen Wen, Chappaqua, NY (US); Stephen P. Wood, Thornwood, NY (US)

(73) Assignee: INTERNATIONAL BUSINESS MACHINES CORPORATION, Armonk, NY (US)

(21) Appl. No.: 13/608,021

(22) Filed: Sep. 10, 2012

(51) Int. Cl. G06Q 10/06

(52) U.S. Cl. 705/7.11

(57) ABSTRACT

Business outcome-based personalized ranking of information objects is provided. Information objects in outcome-based business processes are ranked by recording information objects generated during a creation of the outcome-based business processes. At least one business process comprises an outcome attribute, and at least one business process comprises in-process information objects. A composite graph is generated of the information objects and business processes. Each node in the graph corresponds to an information object or a business process. Links between two information object nodes have a strength based on a content similarity and a social network distance. The in-process information object node connects to a corresponding business process node, and two business process nodes have a link if they are indicated as related in the business process information system. The information objects are ranked based on the link strengths.

### FIELD OF THE INVENTION

The present invention relates to techniques for estimating the value of digital footprints of business activities.

### BACKGROUND OF THE INVENTION

In an enterprise environment, employees often collaborate to generate business results. In this process, they may use collaboration tools and social software (e.g., Lotus Connections) to create content, organize meetings and share documents. These collaboration tools and social software are generating more and more digital footprints that record corresponding activities. The digital footprints can be used, for example, to understand how a business decision is made and/or to determine whether the business decision violates one or more rules or regulations.

Little has been done, however, to rank the business value (e.g., value/risk) of the digital footprints (i.e., the potential of these digital footprints to provide a useful or risky business outcome). For example, the activities that lead to a good outcome can be recommended for future reuse and the activities that lead to a poor result or violations of one or more rules or regulations (such as revealing confidential information) can be identified for further investigation.

A need therefore exists for methods and apparatus for estimating and ranking the business value of the digital footprints.

### SUMMARY OF THE INVENTION

Generally, methods and apparatus are provided for business outcome-based personalized ranking of information objects. According to one aspect of the invention, information objects in one or more outcome-based business processes are ranked by recording information objects generated during a creation of the outcome-based business processes, wherein one or more of the business processes comprise an outcome attribute, and wherein one or more of the business processes comprise one or more in-process information objects; generating a composite graph of the information objects and business processes, wherein each node in the graph corresponds to one of the information objects or one of the business processes, and wherein links between two of the information object nodes have a strength based on a content similarity and a social network distance, and wherein the in-process information object node connects to a corresponding business process node, and wherein two of the business process nodes have a link if they are indicated as related in the business process information system; and ranking the information objects based on the link strengths.

The ranking can be performed, for example, in response to a query comprised of one or more keywords for a given user and a given business process.

In one exemplary embodiment, the content similarity is based on a similarity of content of the information objects and a similarity of timing of the information objects. In addition, the social network distance can be based, for example, on social distance between a user who issues a query and users involved in the information objects. The social network distance is optionally weighted by usage patterns by users of information objects.

In a further variation, a group of related information objects can be identified for one or more particular business processes. The group of related information objects can be based on a list of ranked individual objects. When identifying a group of related information objects, strong link strengths within the group, and weak link strength to outside of the group can be favored. The group of related information objects can be identified, for example, based on a function of a ranking of an individual object with regard to a user query and business-outcome, as well as a relative link strength within the group versus outside of the group.

A more complete understanding of the present invention, as well as further features and advantages of the present invention, will be obtained by reference to the following detailed description and drawings.

### BRIEF DESCRIPTION OF THE DRAWINGS

FIG. 1 illustrates an exemplary organization of a number of information objects;

FIG. 2 provides an overview of a business-outcome-based, personalized information objects ranking system that incorporates aspects of the present invention;

FIG. 3 illustrates an exemplary link construction process that identifies the links between the non-process information objects and in-process information objects of FIG. 2 to construct a composite graph;

FIG. 4 illustrates an outcome-based, personalized information object ranking process that incorporates aspects of the present invention; and

FIG. 5 illustrates an outcome-based, personalized information object group ranking process 500 that incorporates aspects of the present invention.

### DETAILED DESCRIPTION

The present invention provides methods and systems for business-outcome-based and personalized ranking of information objects. According to one aspect of the invention, a composite graph is constructed to link scattered digital footprints, business processes and their outcome by exploiting the semantic relationship among them. The semantic relationship may include, for example, the semantic similarity among the entities and existing links among the entities in provenance software. Then, a graph-based approach is provided to rank the quality (e.g., value/risk) of the digital footprints using the composite graph.

In an enterprise environment, employees and other users often collaborate to generate business results. In this business process, they often use social software, for example, to organize meetings and share documents. Such digital footprints are referred to as information objects in social software. The enterprise may also deploy business process systems to record the outcome (such as positive or negative results) of business and related information objects. However, with conventional techniques, in the proposal preparation process, only final versions of a proposal are typically stored. Thus, many related information objects may not be recorded in a business process.

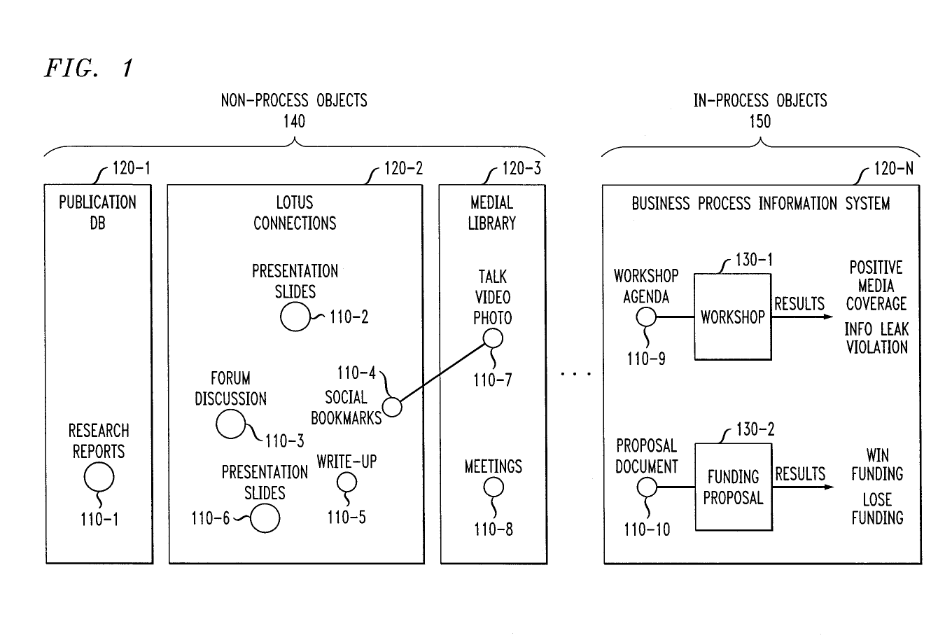

FIG. 1 illustrates an exemplary organization of a number of information objects 110-1 through 110-N. As shown in FIG. 1, information objects 110 are often stored across a plurality of services 120-1 through 120-N. Thus, the information objects 110 are not typically organized by business process. For example, the information objects 110 can comprise research reports 110-1, presentation slides 110-2, video objects 110-7 and forum discussions 110-3; and the services 120 can comprise a publication database 120-1, a Lotus Connections service 120-2, a file sharing media library 120-3 and a business process information system 120-N that records an outcome of one or more business processes, such as a workshop business process 130-1 and/or a funding proposal business process 130-2.

As used herein, the term “in-process objects” 150 comprises information objects that are stored as part of a business process (including information, users and a result) in business process information systems 120-N. The business process information systems 120-N track information created during business processes 130 and whether different business processes 130 are related. In addition, the term “non-process objects” 140 comprises information objects 110 that are generated during the creation of a business process 130, but are not explicitly associated to the business process 130 (including information and users).

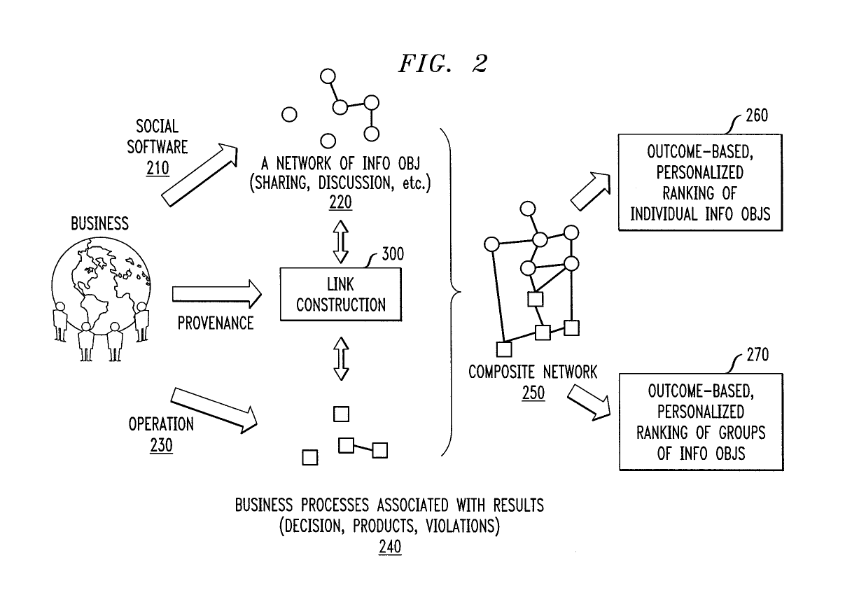

Aspects of the present invention combine in-process objects 150 and non-process objects 140 to build a composite graph 250, as discussed further below in conjunction with FIG. 2. In an exemplary composite graph 250, the nodes can be a business process 130 with an impact value (e.g., an outcome assessment), or the information object 110 of an activity in social software related to the business process 130. The composite graph 250 connects non-process information objects 140 such as information objects 110 in social software and in-process information objects 150 such as the results of the business process 130 of organizing a workshop 130-1 or preparing a funding proposal 130-2. In addition, in-process information object nodes 150 are connected to their corresponding business process nodes 130, and two business process nodes 130 can be connected if they are indicated as related in business process information systems 120-N. In the composite graph 250, the nodes can have attributes, including business outcome, people associated with the business process, and content elements.

The composite graph can be leveraged for outcome-based ranking and mining for frequent activity patterns. For example, a slide presentation can be ranked by the business results of related (directly or indirectly) business processes. As discussed hereinafter, the quality of an object is ranked based on its related objects, including both in-process objects 150 and non-process objects 140. In this manner, a user can query the composite graph to identify prior activities that led to a successful outcome. In addition, a user can query the composite graph to identify prior activities that led to a poor outcome or a rule violation, such as revealing confidential information.

Consider a user that is preparing a funding proposal for a government agency. The user may want to search for documents, presentations, social bookmarks, discussions and/or videos that are related to previous successful proposals. However, as indicated above, with conventional techniques, in the formal proposal preparation process, only final versions of proposal are typically stored. Therefore, it is difficult to link related information non-process objects (e.g., documents, and discussions in social software, such as Lotus Connections) to the outcome.

FIG. 2 provides an overview of an outcome-based, personalized information objects ranking system that incorporates aspects of the present invention. As shown in FIG. 2, a composite graph 250 is automatically constructed from non-process information objects 220 and in-process information objects 240. An enterprise uses social software 210 to generate non-process information objects 220 that have associated results, such as file sharing documents and forum sharing and uses operations software 230 to generate in-process information objects 240 (such as decisions, products and violations).

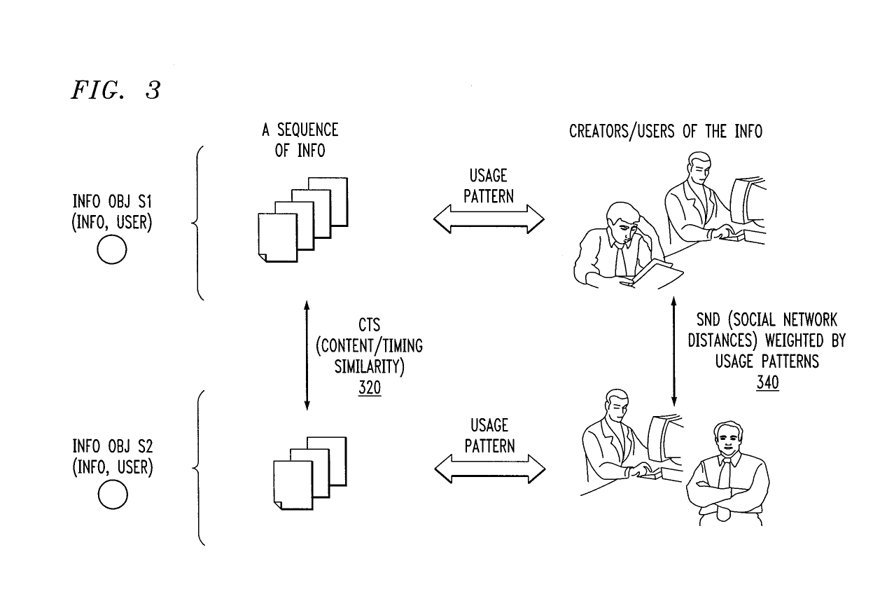

As discussed further below in conjunction with FIG. 3, an exemplary link construction process 300 is employed to identify the links between the non-process information objects 220 and in-process information objects 240 to construct the composite graph 250. As discussed below, the exemplary link construction process 300 utilizes the content similarity of the objects, as well as social distance among people associated with the objects. The composite graph 250 allows an impact-based, personalized ranking 260 of individual information objects 220, as well as an impact-based, personalized ranking 270 of a group of information objects 220.

FIG. 3 illustrates an exemplary link construction process 300 that identifies the links between the non-process information objects 220 and in-process information objects 240 of FIG. 2 to construct the composite graph 250. Consider two exemplary non-process information objects s1 and s2. Each information object s1 and s2 is comprised of a plurality of attributes including a sequence of information in the corresponding information object and a set of one more users associated with the information object.

Generally, the exemplary link construction process 300 utilizes a content similarity (CTS) 320 of the information objects 220, as well as social network distance (SND) 340 among people (such as creators and users) associated with the information objects 220, 240. SND can optionally be weighted by users' usage patterns of information objects. For example, the social network distance of the top users of the information objects can be weighted more.

In one exemplary embodiment, the link strength between two exemplary information objects s1 and s2 can be expressed as follows:

linkStrength(s1,s2)=function(CTS(s1.info,s2.info),SND(s1.user,s2.user))

In one exemplary embodiment, the link strength between information objects 110 and business processes 130 (where each business process 130 comprises information, users and a result) can be expressed as follows:

linkStrength(obj1,proc1)=1(if obj1 is in-process object 150), or 0 otherwise

linkStrength(proc1,proc2)=1(if proc1 and proc2 are indicated as related in the business process information system 120-N), or 0 otherwise.

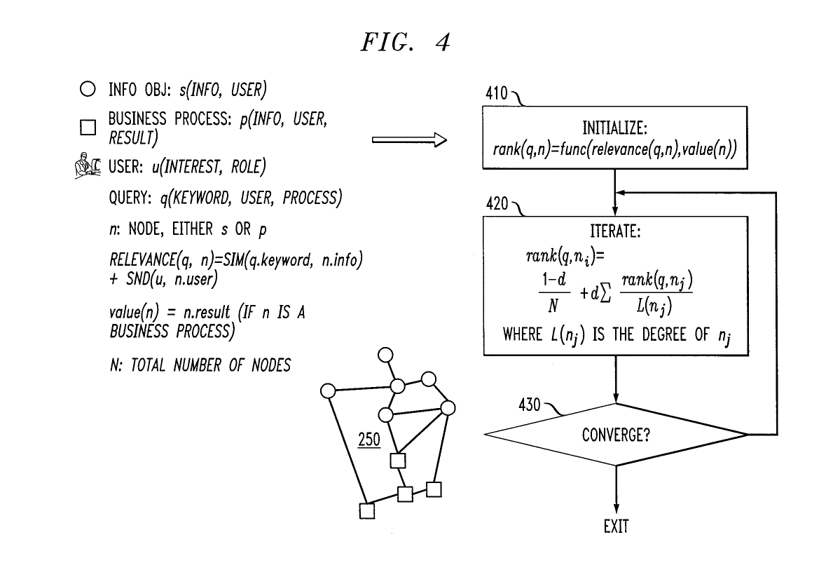

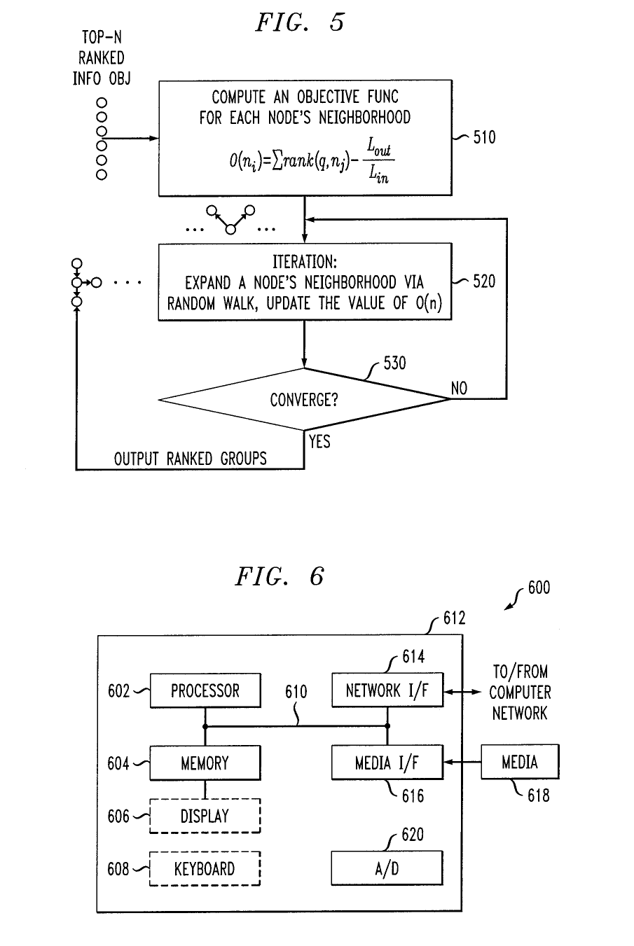

As indicated above, the composite graph 250 of FIG. 2 allows an impact-based, personalized ranking 260 of individual information objects 220, as discussed further below in conjunction with FIG. 4, as well as an impact-based, personalized ranking 270 of a group of information objects 220, as discussed further below in conjunction with FIG. 5.

FIG. 4 illustrates an outcome-based, personalized information object ranking process 400 that incorporates aspects of the present invention. When users search for information objects 220 in social software, it is desirable to consider the potential impact of the activities, as well as the relevance of the activities to the user who issues the query. The composite graph 250 of in-process objects 240 and non-process objects 220 allows the potential impact of the activities, as well as the relevance of the activities to the user who issues the query to be considered. In the composite graph 250, a non-process object 220 is (directly or indirectly) connected with in-process objects 240 with outcome. Therefore, a graph ranking algorithm 400 can incorporate the outcome value of in-process objects 240 to rank non-process objects 220 in social software. In addition, a business process or an object in social business software involves a group of users. An exemplary ranking algorithm 400 can consider social distances between the user who issues the query and the users involved in social activities to obtain personalized ranking.

As shown in FIG. 4, the personalized information object ranking process 400 initially initializes a ranking function during step 410, as follows:

rank(q,n)=relevance(q,n)+value(n)

where the relevance(q,n)=sim(q.keyword,n.info)+SND(u, n.user) and value(n)=n.result (if n is a business process).

The personalized information object ranking process 400 then iterates during step 420 over the ranking function as follows:

$$rank ( q , {n}_{i} ) = \frac{1 - d}{N} + d \sum \frac{rank ( q , {n}_{j} )}{L ( {n}_{j} )}$$

where L(nⱼ) is the degree of nⱼ.

Finally, a test is performed during step 430 to determine if the ranking function converges. If it is determined during step 430 that the ranking function does not converge, then program control returns to step 420. If however, it is determined during step 430 that the ranking function converges, then the process 400 exits.

FIG. 5 illustrates an outcome-based, personalized information object group ranking process 500 that incorporates aspects of the present invention. When users perform outcome-based searches, they often desire to find a group of highly related objects for particular business processes. Such a group will be particularly helpful to users that are new or inexperienced to the corresponding processes. Based on a list of ranked individual objects by the method 400 of FIG. 4, the exemplary system further defines an objective function on a group of objects that favors strong link strengths within the group, and weak link strength to outside of the group. Initially, each group only contains one object. Then, an optimization approach expands the groups until it reaches an optimal value for the objective function.

As shown in FIG. 5, the exemplary outcome-based, personalized information object group ranking process 500 processes the Top-N ranked individual information objects 220, 240 from FIG. 4 during step 510 to compute an objective function for each node's neighborhood, as follows:

O(nᵢ)=Σrelevance(q,nⱼ)

The exemplary outcome-based, personalized information object group ranking process 500 iterates during step 520 by expanding a node's neighborhood via a random walk, and updating the value of O(n).

Finally, a test is performed during step 530 to determine if the objective function converges. If it is determined during step 430 that the objective function does not converge, then program control returns to step 520. If, however, it is determined during step 530 that the objective function converges, then the process 500 outputs the ranked groups.

Exemplary System and Article of Manufacture Details

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof, can be implemented in the form of an apparatus including a memory and at least one processor that is coupled to the memory and operative to perform exemplary method steps.

One or more embodiments can make use of software running on a general purpose computer or workstation. FIG. 6 depicts an exemplary computer system 600 that may be useful in implementing one or more aspects and/or elements of the present invention. For example, one or more of wireless network transmitter 140 and mobile client 160 of FIG. 1 can be implemented using the computer system 600. With reference to FIG. 6, such an implementation might employ, for example, a processor 602, a memory 604, and an input/output interface formed, for example, by a display 606 and a keyboard 608.

The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like.

In addition, the phrase “input/output interface” as used herein, is intended to include, for example, one or more mechanisms for inputting data to the processing unit (for example, mouse), and one or more mechanisms for providing results associated with the processing unit (for example, printer). The processor 602, memory 604, and input/output interface such as display 606 and keyboard 608 can be interconnected, for example, via bus 610 as part of a data processing unit 612. Suitable interconnections, for example via bus 610, can also be provided to a network interface 614, such as a network card, which can be provided to interface with a computer network, and to a media interface 616, such as a diskette or CD-ROM drive, which can be provided to interface with media 618.

Analog-to-digital converter(s) 620 may be provided to receive analog input, such as analog video feed, and to digitize same. Such converter(s) may be interconnected with system bus 610.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 602 coupled directly or indirectly to memory elements 604 through a system bus 610. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 608, displays 606, pointing devices, and the like) can be coupled to the system either directly (such as via bus 610) or through intervening I/O controllers (omitted for clarity).

Network adapters such as network interface 614 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 612 as shown in FIG. 6) running a server program. It will be understood that such a physical server may or may not include a display and keyboard.

As noted, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Media block 618 is a non-limiting example. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the FIGS. illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Method steps described herein may be tied, for example, to a general purpose computer programmed to carry out such steps, or to hardware for carrying out such steps, as described herein. Further, method steps described herein, including, for example, obtaining data streams and encoding the streams, may also be tied to physical sensors, such as cameras or microphones, from whence the data streams are obtained.

It should be noted that any of the methods described herein can include an additional step of providing a system comprising distinct software modules embodied on a computer readable storage medium. The method steps can then be carried out using the distinct software modules and/or sub-modules of the system, as described above, executing on one or more hardware processors 402. In some cases, specialized hardware may be employed to implement one or more of the functions described here. Further, a computer program product can include a computer-readable storage medium with code adapted to be implemented to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for ranking information objects in one or more outcome-based business processes, comprising:
recording information objects generated during a creation of said outcome-based business processes, wherein one or more of said business processes comprise an outcome attribute, and wherein said information objects comprise one or more in-process information objects and one or more non-process information objects, wherein each in-process information object comprises an information object that is stored as part of a business process and each non-process information object comprises an information object that is generated during an activity of social network software that is not explicitly associated to the business process;
generating a composite graph of said information objects and business processes that identifies one or more links between the one or more non-process information objects and the one or more in-process information objects, wherein each node in said graph corresponds to one of said information objects or one of said business processes, and wherein each of the one or more links between the one or more non-process information objects and the one or more in-process information objects has a strength based on a content similarity and a social network distance, wherein said content similarity is based on (i) a similarity of content of said information objects and (ii) a similarity of timing of said information objects occurring within one or more activity patterns associated with said business processes, and wherein said in-process information object node connects to a corresponding business process node, and wherein two of said business process nodes have a link if they are indicated as related in the business process information system; and
ranking said information objects based on said link strengths;
wherein each of the steps is carried out by a computer device.

2. The method of claim 1, wherein one or more of said information objects comprise one or more information attributes, user attributes and an outcome.

3. The method of claim 2, wherein said user attributes comprise an interest attribute and a role attribute.

4. The method of claim 1, wherein said ranking is performed in response to a query comprised of one or more keywords for a given user and a given business process.

5. (canceled)

6. The method of claim 1, wherein said social network distance is based on social distance between a user who issues a query and users involved in said information objects.

7. The method of claim 1, further comprising the step of identifying a group of related information objects for one or more particular business processes.

8. The method of claim 7, wherein said group of related information objects is based on a list of ranked individual objects.

9. The method of claim 7, wherein said step of identifying a group of related information objects favors strong link strengths within the group, and weak link strength to outside of the group.

10. The method of claim 7, wherein said step of identifying a group of related information objects is based on a function of a ranking of an individual object with regard to a user query and business-outcome.

11. The method of claim 1, wherein said social network distance is weighted by usage patterns by users of information objects.
